(19) United States
(12) Patent Application Publication
(10) Pub. No.: US 2022/0414259 A1
(43) Pub. Date: Dec. 29, 2022

(54) Systems and Methods for Electronic Data Privacy, Consent, and Control in Electronic Transactions

(71) Applicant: Qonsent Inc., Westport, CT (US)

(72) Inventors: Jesse Redniss, Westport, CT (US); Seth Redniss, North Salem, NY (US); Stephano Kim, New York, NY (US); Marc Scibelli, Trumbull, CT (US); Will Lowry, Palo Alto, CA (US)

(73) Assignee: Qonsent Inc., Westport, CT (US)

(21) Appl. No.: 17/749,767

(22) Filed: May 20, 2022

Related U.S. Application Data
(60) Provisional application No. 63/215,320, filed on Jun. 25, 2021.

(51) Int. Cl. G06F 21/62; G06Q 30/02

(52) U.S. Cl. CPC G06F 21/6245; G06Q 30/0255; G06Q 50/01

(57) ABSTRACT

Systems and methods for electronic data privacy, consent, and control in electronic transactions are provided. The system includes a customized software application executing on a computing device which provides the electronic data privacy, consent, and control functions in order to allow a user to control the dissemination and usage of PII during an electronic transaction with a third party such as a vendor, service provider, manufacturer, advertiser, etc. The system provides a single platform whereby the user only needs to provide his/her PII once, and the usage and control of such information is administered by the system. The system significantly increases the speed and efficiency with which electronic transactions are processed, and also significantly reduces data privacy risks associated with having to supply PII on multiple portals.

### RELATED APPLICATIONS

The present application claims the priority of U.S. Provisional Application Ser. No. 63/215,320 filed on Jun. 25, 2021, the entire disclosure of which is expressly incorporated herein by reference.

### BACKGROUND

### Technical Field

The present disclosure relates to the field of electronic transactions. More specifically, the present disclosure relates to systems and methods for electronic data privacy, consent, and control in electronic transactions.

### Related Art

In today's world of electronic commerce and transactions, the need to preserve and protect data privacy is paramount. Sensitive personal data, such as personally-identifiable information (PII), is often collected during electronic transactions conducted over various online registration, electronic commerce, and online marketing and advertising platforms and systems. Moreover, PII is highly sought-after by marketers, retailers, advertisers and other entities so as to maximize opportunities to target advertising, and tailor customer messaging and marketing offers to specific individuals based on PII of that individual, in order to increase the probability, frequency, and quality of engagement with that individual

Unfortunately, it is difficult for individuals to adequately monitor and control the collection/mining of PII when engaging in electronic transactions. All too often, such individuals are required to submit their PII in order to even engage in an electronic transaction (even at the most basic level and non-commercial levels) in the first instance, to receive special offers provided by marketers, or to engage in other desired online commercial and non-commercial activities. In relinquishing control of PII, such individuals increase the risk of being the target of identity theft or other crimes, as well as the possibility and increasing likelihood of undesired or nefarious use of such PII.

Accordingly, what would be desirable are systems and methods for electronic data privacy, consent, and control in electronic transactions, which address the foregoing, and other, needs.

### SUMMARY

The present disclosure relates to systems and methods for electronic data privacy, consent, and control in electronic transactions. The system includes a customized software application executing on a computing device which provides the electronic data privacy, consent, and control functions in order to allow a user to control the dissemination and usage of PII during an electronic transaction with a third party such as a vendor, service provider, manufacturer, advertiser, etc. The system provides a single location for collecting and controlling PII in a digital “wallet,” and also acts as an authorized digital agent for controlling and transmitting such information. The system provides a single platform whereby the user only needs to provide his/her PII once, and the usage and control of such information is administered by the system. The system significantly increases the speed and efficiency with which electronic transactions are processed, and also significantly reduces data privacy risks associated with having to supply PII on multiple portals. The system leverages a methodology by which an end user of the system is validated against at least 3 points of qualified data in order to confirm that the user is not a “bot” and/or a fraudulent user. The system is comprised of the multiple functions described herein which can interoperate or function independently.

### BRIEF DESCRIPTION OF THE DRAWINGS

The features of the present disclosure will be apparent from the following Detailed Description, taken in connection with the accompanying drawings, in which:

FIG. 1 is a high-level diagram illustrating the systems/methods of the present disclosure;

FIG. 2 is a screenshot illustrating a PII management “wallet” in accordance with the present disclosure;

FIG. 3 is a screenshot illustrating a PII consent and control screen generated by the system of the present disclosure;

FIGS. 4A-4C are screenshots illustrating PII revocation screens generated by the system of the present disclosure;

FIG. 5 illustrates screenshots of user enrollment screens generated by the system of the present disclosure;

FIG. 6 illustrates additional screenshots of PII consent and control screens generated by the system of the present disclosure;

FIG. 7 illustrates a QR code reader feature of the system of the present disclosure;

FIG. 8 illustrates a user interface screen generated by the system for collecting PII from a user;

FIG. 9 illustrates a user interface screen generated by the system for specifying a time period for which sharing of PII with another party is permitted;

FIG. 10 is a screenshot of a user interface screen for accessing and managing PII;

FIG. 11 is a flowchart illustrating processing steps carried out by the systems and methods of the present disclosure;

FIG. 12 illustrates a QR code reader enabled multi-screen authentication feature of the system of the present disclosure;

FIG. 13 illustrates screenshots of parental consent screens generated by the system of the present disclosure;

FIG. 14 illustrates screenshots of parental monitoring screens generated by the system of the present disclosure;

FIG. 15 illustrates a QR code reader enabled offer redemption feature of the system of the present disclosure;

FIGS. 16A-16B are screenshots illustrating single sign-on screens generated by the system of the present disclosure;

FIG. 17 illustrates a QR code reader enabled offer redemption feature of the system of the present disclosure;

FIGS. 18A-18B are screenshots illustrating value exchange offer screens generated by the system of the present disclosure;

FIG. 19 is a screenshot illustrating embedded access to the features of the systems and methods of the present disclosure in-line within an advertisement (e.g., an advertisement in a social media feed); and

FIG. 20 is a screenshot illustrating a user interface screen for accessing and managing PII associated with an entity associated with the embedded advertisement of FIG. 19.

### DETAILED DESCRIPTION

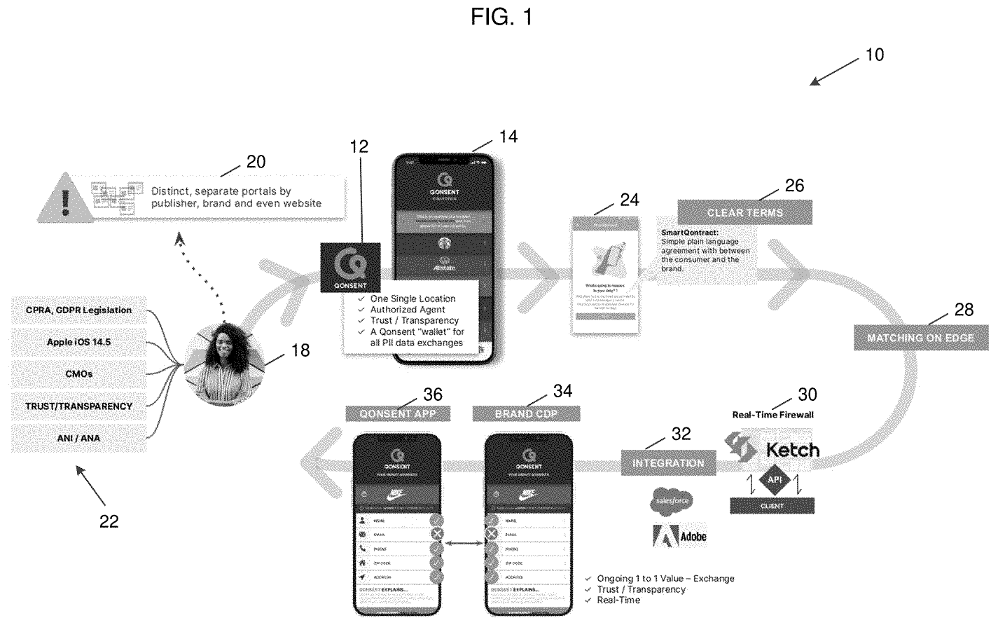

The present disclosure relates to systems and methods for electronic data privacy, consent, and control in electronic transactions, as discussed in detail below in connection with FIGS. 1-20.

FIG. 1 is a high-level diagram illustrating the systems/methods of the present disclosure, indicated generally at 10. The system 10 includes a software application 12 executing on a computing device 14, such as a smart phone, laptop computer, desktop computer, or tablet computer, or other suitable computing device. The application 12 (also referred to in the drawings as the “Qonsent” application) provides the electronic data privacy, consent, and control functions disclosed herein, in order to allow a user 18 to control the dissemination and usage of PII during an electronic transaction with a third party such as a vendor, service provider, manufacturer, advertiser, etc. The system 10 provides a single location for collecting and controlling PII in a digital “wallet” as discussed in greater detail below, and also acts as an authorized digital agent for controlling and transmitting such information. In so doing, the system 10 engenders trust and transparency for the user 18, in connection with storage and usage of the PII of the user 18.

Advantageously, the system 10 provides a single platform whereby the user 18 only needs to provide his/her PII once, and the usage and control of such information is administered by the system 10 in connection with one or more third-party portals 20. This way, the user 18 need not provide PII in the conventional fashion (e.g., using one or more of the third-party portals 20), thereby significantly increasing the speed and efficiency with which electronic transactions are processed, and also significantly reducing data privacy risks associated with having to supply PII on multiple portals (such as the portals 20). Also, it is noted that usage and administration of the user 18's PII by the platform 10 could be in accordance with one or more rules 22, such as data privacy legislation (e.g., CPRA, GDRP legislation, etc.), operating system rules, and other rules.

The user 18 can enroll in the system 10 and supply his/her PII information to the system 10. Access, usage, and control of such PII can then be administered in accordance with one or more contracts (which are presented to the user in a clear, simple and explicit manner) 24 entered into between the user 18 and one or more entities, such as a retailer, brand owner, wholesaler, vendor, service provider, or any other desired entity. The contract can be implemented as a blockchain contract, whereupon terms relating to access, usage, and control of the user's PII by the entity is embedded within the blockchain contract. Once the contract is formulated, the terms of the contract are cleared by the platform 10 in process 26. Then, in process 28, the system electronically monitors usage of the user's PII by the entity, to ensure that such usage is in accordance with the terms and conditions of the contract 24. Such monitoring (“watching”) can occur at any location in a communications network, e.g., at the edge (on an end node) of the network.

The platform 30 includes a real-time firewall 30 and an integration software engine 32 that allows one or more computer systems of the entities noted above (e.g., retailers, brand owners, wholesalers, vendors, service providers, etc.) to communicate with the platform 10. It is noted that a number of the functions disclosed herein and provided by the platform 10 could be supported by one or more back-office computing systems (e.g., one or more cloud computing devices/platforms, servers, etc.) not illustrated in FIG. 1, which are in communication with both the application 12 as well as the entities noted above. Using the application 12, the user 18 can electronically control usage of PII by any of the aforementioned entities, in real time, using customized user interface screens 34, 36 generated by the system. Such user interface screens will be described in greater detail below, and include a PII management “wallet” that provides a central facility for allowing the user 18 to control access and usage of the user's PII by multiple third parties.

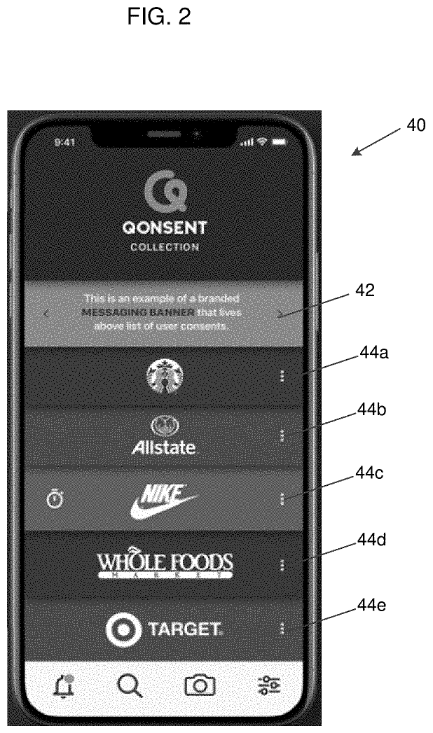

FIG. 2 is a screenshot illustrating a PII management “wallet” in accordance with the present disclosure, indicated at 40. The wallet 40 is a customized, special-purpose user interface generated and displayed by the application 12 on the user's computer device (e.g., cell phone), and includes graphical user interface elements that allow the user to very rapidly access information about authorized entities to which the user has consented to usage of the user's PII. For example, as shown in FIG. 2, the wallet 40 could include a plurality of entity “cards” 44a-44e, each corresponding to a particular vendor for which the user has consented to allow usage of the user's PII in accordance with a contract. By tapping on one of the cards 44a-44e, the user can access the terms and conditions currently in force between the user and the respective vendor, and can also control usage of the user's PII by that vendor, as well as granting or revoking PII usage privileges for that vendor.

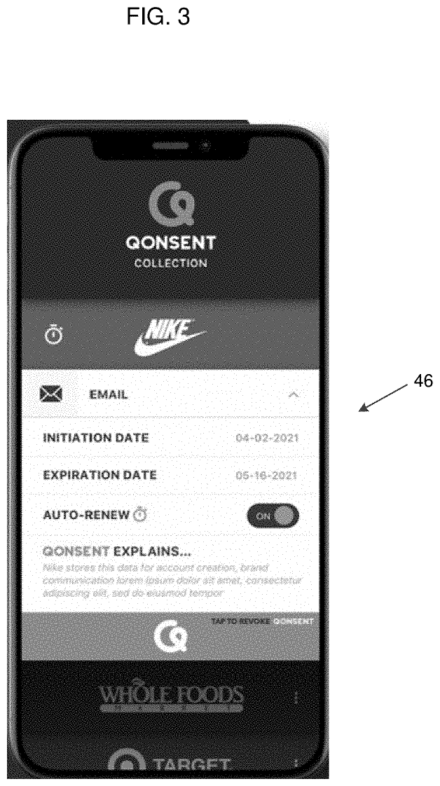

FIG. 3 is a screenshot illustrating a PII consent and control screen generated by the system of the present disclosure, indicated generally at 46. The screen 46 allows the user to electronically grant consent to a vendor (in this case, NIKE, INC.) to access and utilize the user's e-mail address in connection with electronic transactions with the vendor, and to also specify start and ending dates for such usage. Additionally, the user can allow for such consent to automatically renew after expiration of the specified time range by tapping an “Auto-Renew” icon in the screen 46.

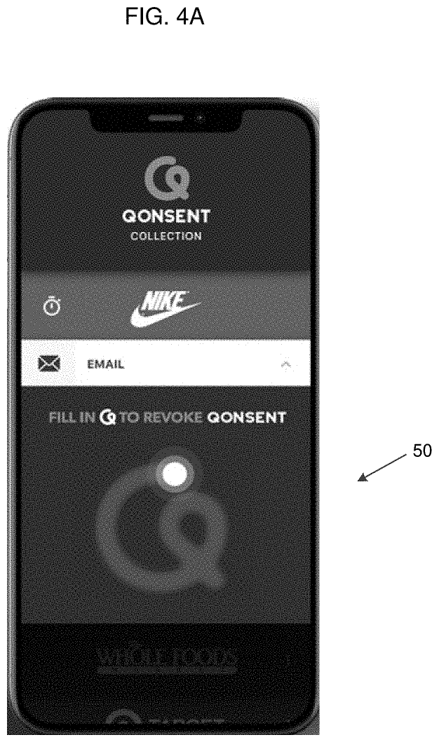

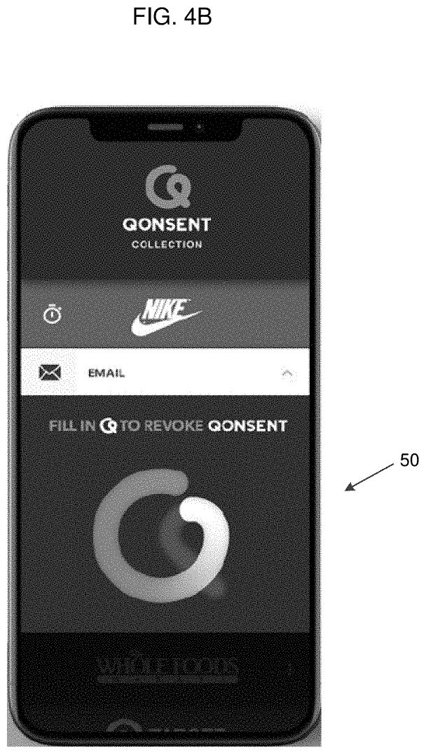

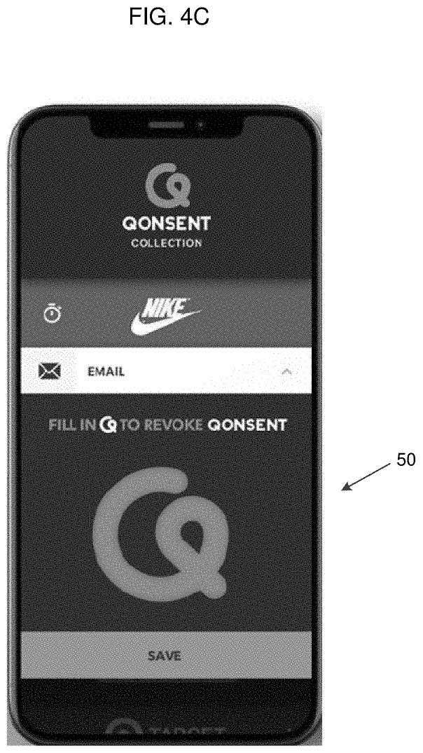

FIGS. 4A-4C are screenshots illustrating PII revocation screens generated by the system of the present disclosure. A customized revocation screen 50 allows the user to select an entity that currently is authorized to utilize the user's PII in accordance with the terms of the contract, and to revoke future usage of the user's PII by the entity by hand-drawing (tracing on the screen of a smart phone, for example) a symbol, such as the “Q” symbol shown in FIGS. 4A-4C. Once the symbol has been hand drawn, the system revokes authorization of the entity to use the user's PII in the future. Of course, other types of interfaces are possible.

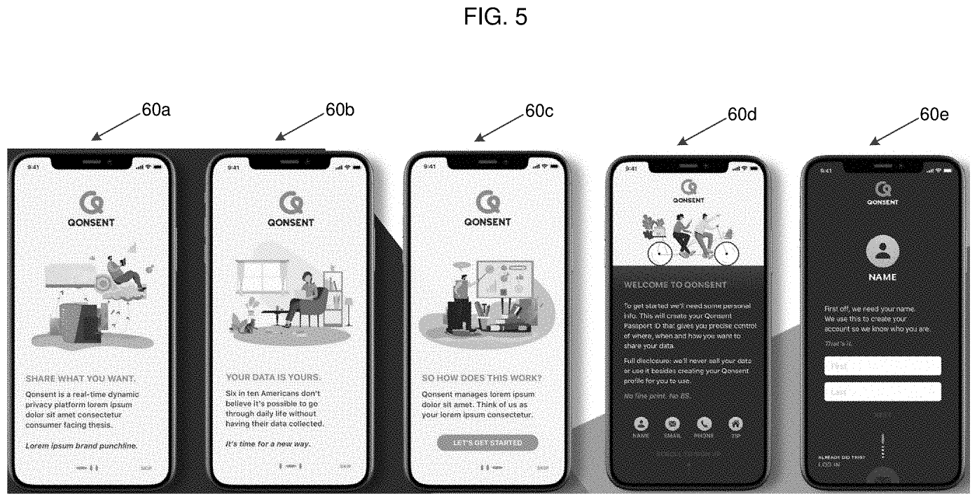

FIG. 5 illustrates screenshots of user enrollment screens generated by the system of the present disclosure. Screens 60a-60d provide general information about the services provided by the system, including, but not limited to the PII consent and control features of the system. As shown in screen 60e, the user begins enrollment in the system by providing the user's full name. Other information, as needed, is gathered by the system in order to enroll the user.

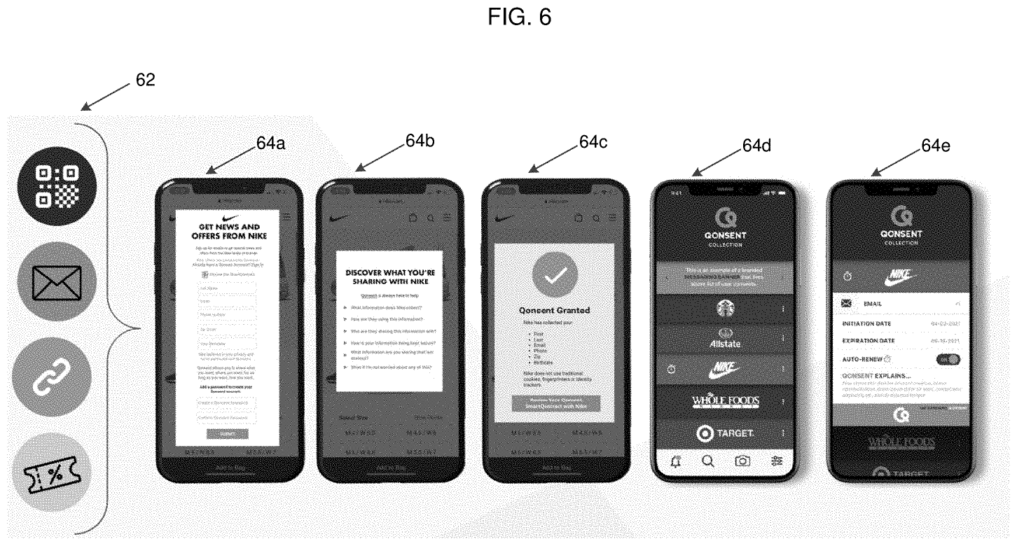

FIG. 6 illustrates additional screenshots of PII consent and control screens generated by the system of the present disclosure. The interface screen 64a allows the user to obtain news and offers from a vendor, or other desired information 62 (e.g., sales, events, services, etc.). The screen 64b informs the user as to what specific types of PII will be shared by the system with vendor. In screen 64c, the user can consent to the sharing of such PII, in accordance with the terms of a contract entered into between the user and the vendor. Once the vendor is authorized, a customized PII card is displayed in the interface screen 64d (which corresponds to the PII wallet discussed above). Each individual PII card can be accessed (with controls for controlling/monitoring PII usage) in the screen 64e.

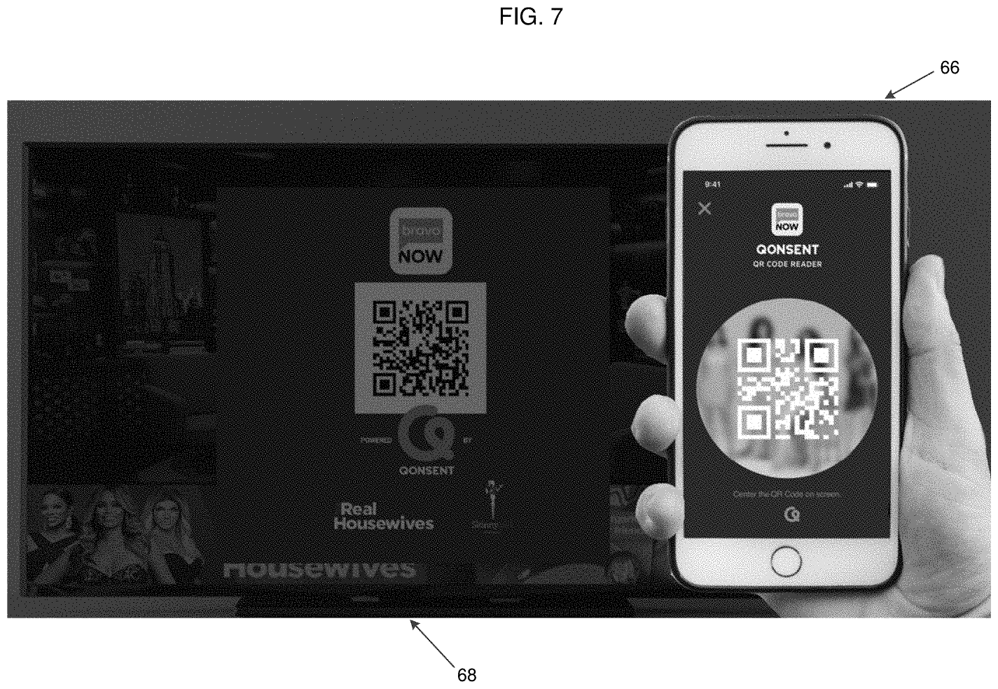

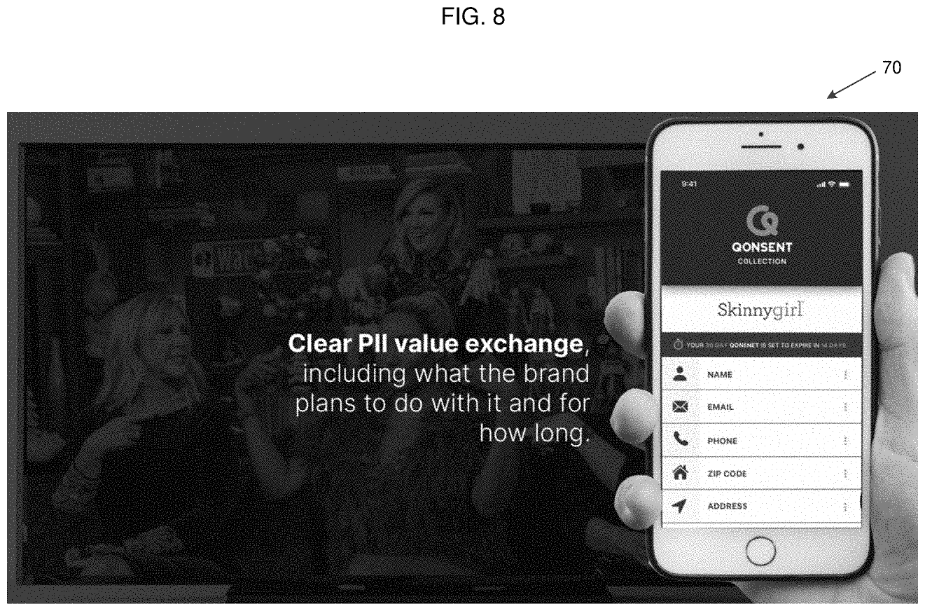

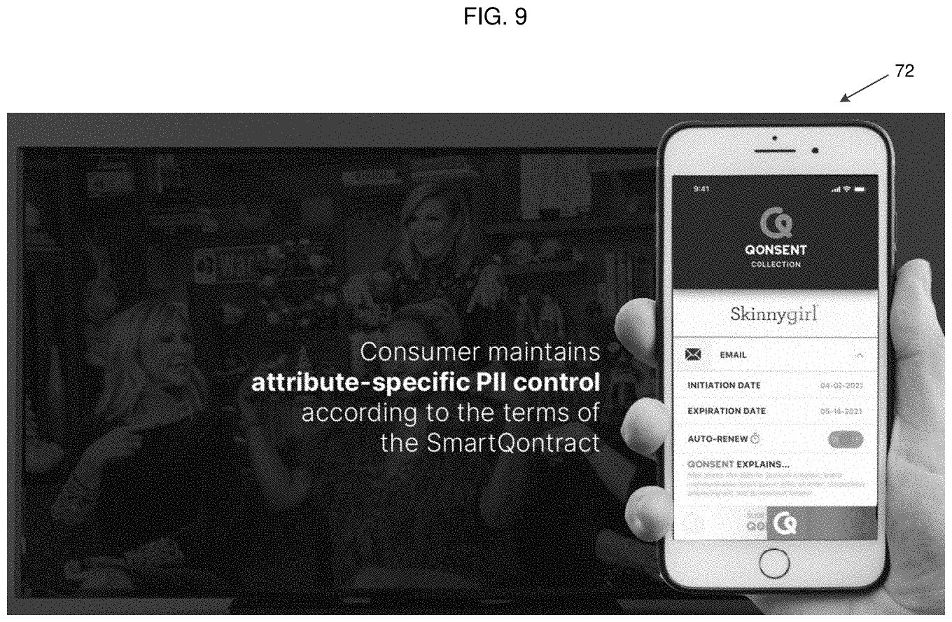

FIG. 7 illustrates a QR code reader feature of the system of the present disclosure. Using the interface screen 66 generated by the system, the user can capture an image (e.g., using the camera of a smart phone) of a QR code displayed by a vendor/advertiser/third party/etc., such as a QR code displayed on a television screen 68. Once the QR code has been captured, the system processes the code to identify and retrieve information provided by the entity, such as a sales offer. As shown in FIG. 8, the system then generates a PII data collection screen 70, whereupon the user can choose to enter PII that the user is comfortable sharing with the entity (including, but not limited to, name, e-mail, phone, zip code, address, etc.). As shown in FIG. 9, the system also generates a second screen 72 which allows the user to specify a time period for which sharing of PII with the entity is permitted, as well as for automatically renewing consent to such sharing, if desired.

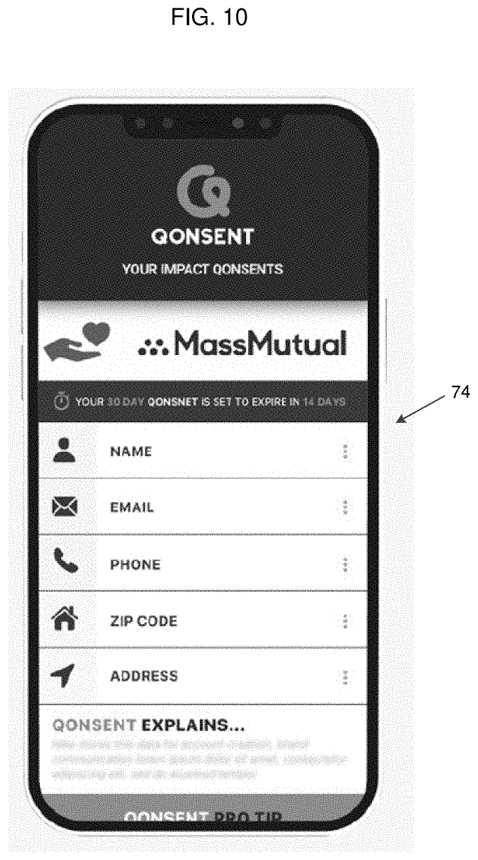

FIG. 10 is a screenshot of a user interface screen for accessing and managing PII, indicated at 74. In this screen, the user can control what PII is being shared with an entity, such as the user's name, e-mail, phone number, zip code, address, etc. Additionally, the system identifies for the user when the current consent period is about to expire (e.g., consent to sharing of the PII noted in the screen 74 expires in 14 days, for example).

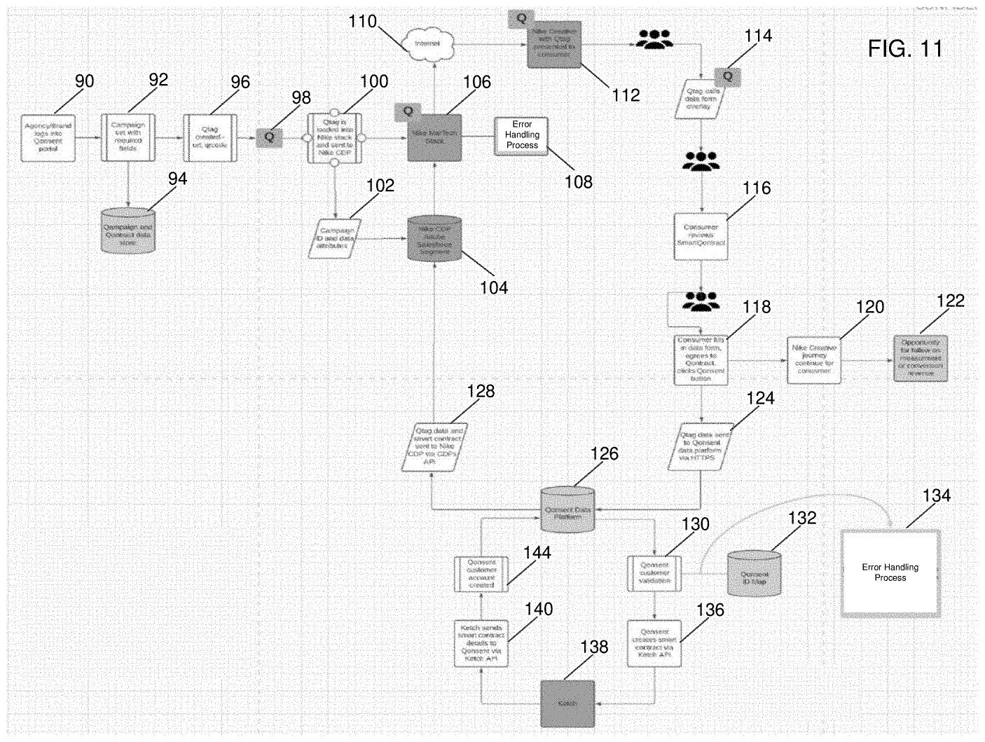

FIG. 11 is a flowchart illustrating processing steps carried out by the systems and methods of the present disclosure. Beginning in step 90, an entity (such as an agency, brand owner, vendor, etc.) logs into the Qonsent system. In step 92, the entity can create a branding campaign that includes required data fields, and the supplied information is stored in database 94. In step 96, the system creates a unique campaign identifier “tag” that includes a Uniform Resource Locator (URL) address and/or a QR code that is tied to the brand and the campaign. The tag is then sent via API to the brands data platform for use in the campaign. In step 98, the system is then updated with the created URL and QR code. In step 100, the system transmits the tag via an API to one or more of the brand's data platform. In step 102, data relating to the campaign identifier as well as specific data attributes are ingested and stored into the brand's data platform 104. In step 106, the system retrieves one or more data attributes stored in the brand's data platform, and provides access to advertising campaigns associated with the tags via the Internet 110. An optional error handling process 108 could also be provided, for handling error associated with stack loading, processing, etc.

In step 112, the system presents a web based landing page to the consumer and simultaneously retrieves a tag associated with the brand campaign for the data request form overlay. In step 114, the system retrieves and processes any required overlay data associated with the tag (e.g., for formatting the offer in a particular way specified in the tag, etc.). The request form is filled in by the consumer based on the campaign specifics the brand previously setup in the Qonsent system. In step 116, the system presents the user with a contract, customized for usage with the entity. In step 118, the user (e.g., customer) fills in the required information, agrees to the contract, and consents to sharing of PII with the entity. If the consumer agrees then the process moves forward and if they do not agree then the page closes and the process stops. In step 120, the user then engages with the entity and shares PII with the entity in the manner described hereinabove. Optionally, in step 122, the system can perform one or more measurements and/or analytics associated with interaction between the entity and the user, and/or monetize such information, if desired. Once the data contract has been entered into between the parties, step 124 occurs, wherein the tag is sent to the system via an API, and all information relating to the data contract, the PII parameters, and the tag is stored in a database 126. In step 128, the entity is provided with the data contract and any other required information from the database 126, via the brand's data platform.

In step 130, the system can perform one or more customer validation processes, in consultation with a consent database 132 that maps one or more consent settings with the user. An error handling process 134 could be called, if needed, to resolve any issues associated with validating user consent to PII sharing. In step 136, the system creates a data contract via an API to a data contract ledger platform. In step 138, the data contract creation platform records, encrypts the contract via the API call, and in step 140, the ledger system sends the data contract details to the system via an API call. In step 144, the customer's account is updated, and the contract is stored in the database 126 and associated with the customer.

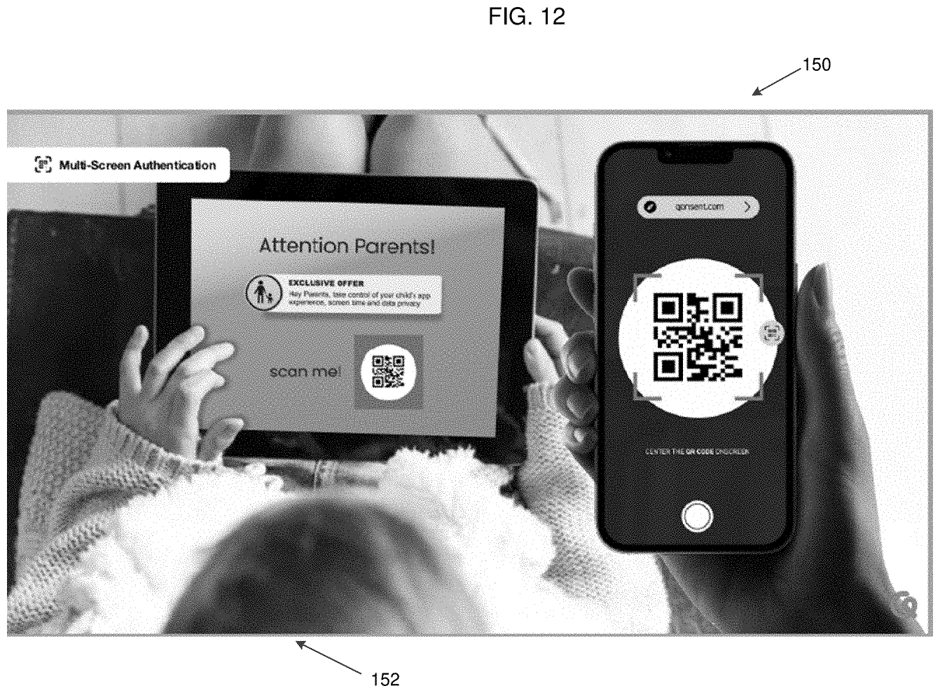

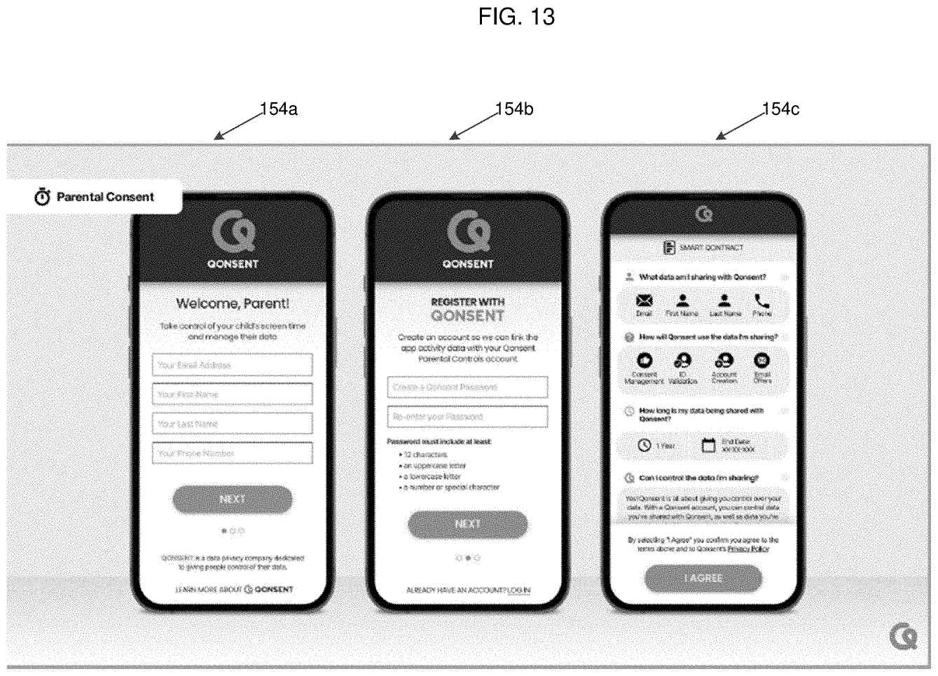

FIG. 12 illustrates a QR code reader enabled multi-screen authentication feature of the system of the present disclosure. Using the interface screen 150 generated by the system, a parent user can capture an image (e.g., using the camera of a smart phone) of a QR code displayed by an application running on a phone/computer/tablet/etc., such as a QR code displayed on a tablet 152. Once the QR code has been captured, the system processes the code to identify and retrieve information provided by the application, such as a parental consent form. As shown in FIG. 13, the system then generates a parent registration screen 154a, whereupon the parent user can choose to enter PII that the parent user is comfortable sharing with the entity (including, but not limited to, name, e-mail, phone, zip code, address, etc.). The system also generates a second screen 154b which allows the parent user to create a PII management account or to login with an existing account. The system also generates a third screen 154c which allows the parent user to specify a time period for which sharing of PII with the application is permitted. In some embodiments, the system only illustrates screens 154a and 154c, omitting the login or account creation process.

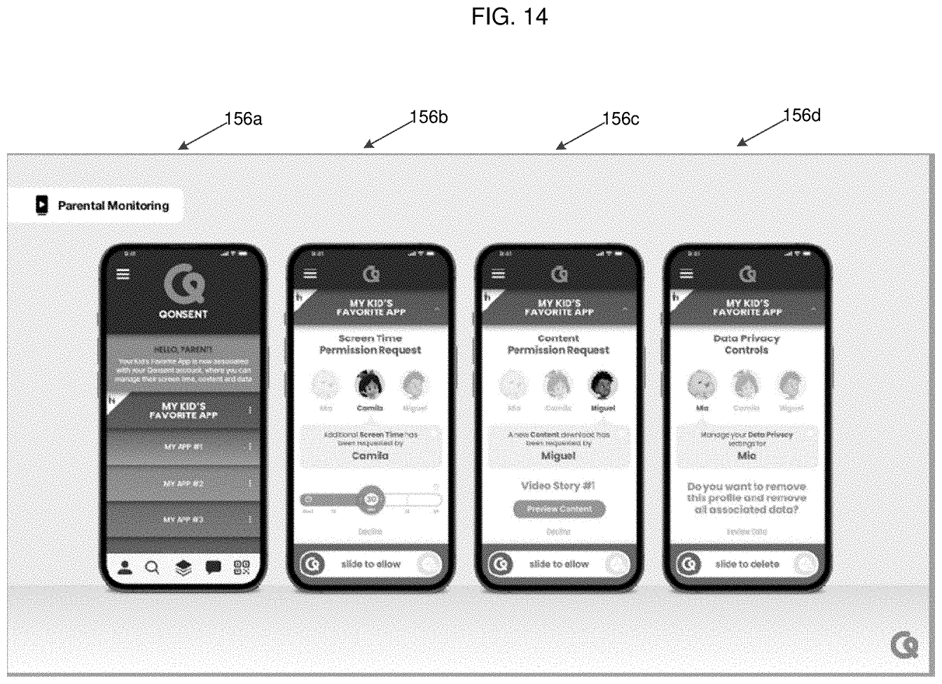

FIG. 14 illustrates screenshots of parental monitoring screens generated by the system of the present disclosure. The system generates a first screen 156a listing one or more child's applications registered with the system. The system also generates a second screen 156b displaying a child's request for additional screen time. The parent user may grant the request to prevent an application from shutting down due to expiration of allowed screen time. The system also generates a third screen 156c displaying a child's request to view restricted content within an application. The parent user may preview the requested content within the third screen 156c. The system also generates a fourth screen 156d which allows the parent user to remove a child profile and associated data. Screens 156b, 156c and 156d may be generated upon selection of an application in first screen 156a.

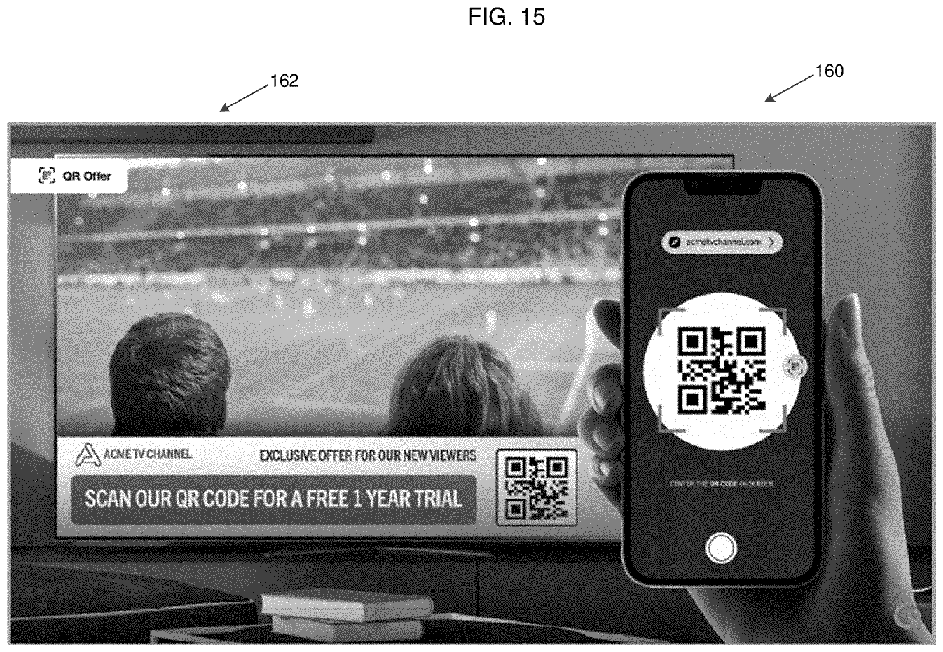

FIG. 15 illustrates a QR code reader enabled offer redemption feature of the system of the present disclosure. Using the interface screen 160 generated by the system, a user can capture an image (e.g., using the camera of a smart phone) of a QR code displayed by a vendor/advertiser/third party/etc., such as a QR code displayed on a television screen 162. Once the QR code has been captured, the system processes the code to identify and retrieve information provided by the application, such as a sales offer.

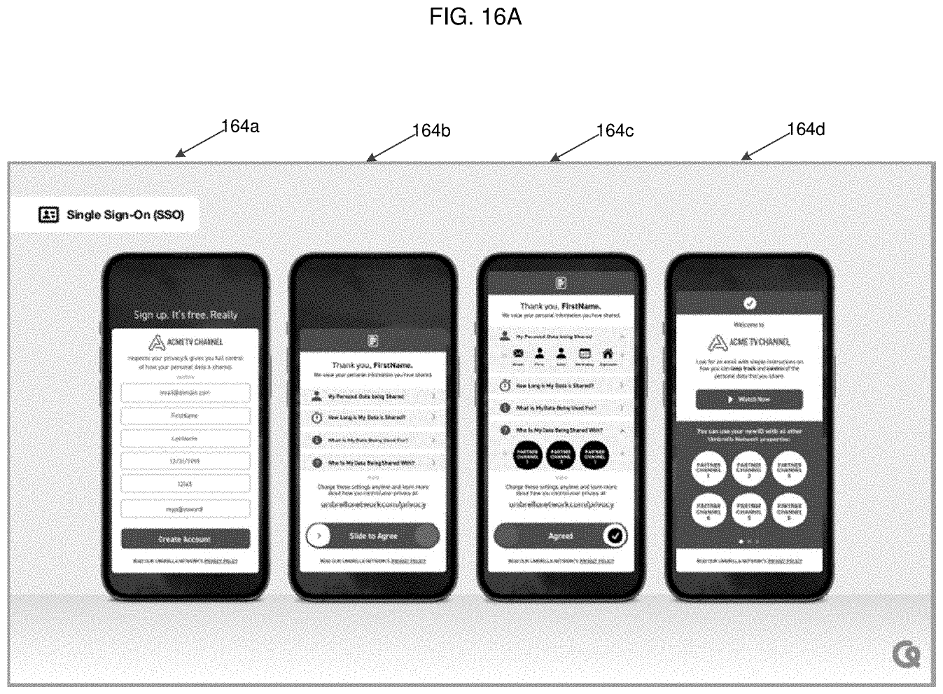

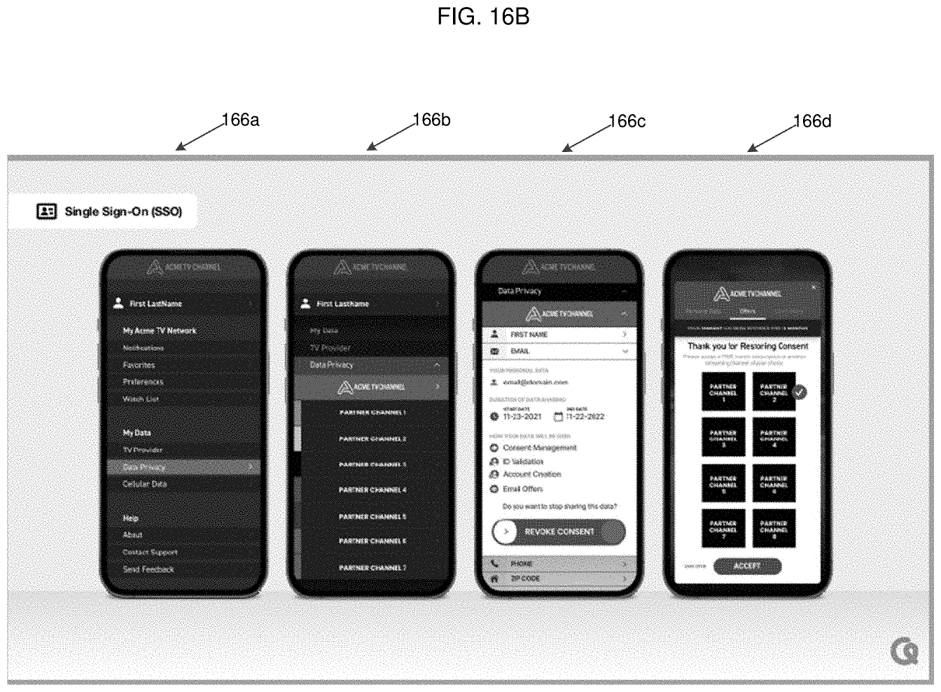

FIGS. 16A-16B are screenshots illustrating single sign-on screens generated by the system of the present disclosure. The single sign-on screens depicted in FIG. 16A may be generated after scanning a QR code as described with reference to FIG. 15. The system generates a first screen 164a providing an account creation form. The account creation form may be auto-populated with PII stored in the system. The system also generates a second screen 164b depicting privacy policies associated with the account created in screen 164a. The system also generates a third screen 164c depicting PII sharing policies associated with the account created in screen 164a. The system also generates a fourth screen 164d which allows the user to begin using the service associated with the account created in screen 164a.

The screens depicted in FIG. 16B are generated after creating an account with a service, for example a service advertised in a sales offer as described with reference to FIG. 15. The system generates a first screen 166a providing account management options, including for example data privacy. Upon selection of data privacy, the system also generates a second screen 166b depicting a menu selection of services with access to the user's PII, for example the service the user is currently signed in to and associated partner services. The system also generates a third screen 166c depicting PII usage policies associated with the service selected in screen 166b. In some embodiments, screen 166c includes an option to revoke or restore consent to utilize the user's PII. The system also generates a fourth screen 166d confirming the decision to revoke or restore consent to use the PII.

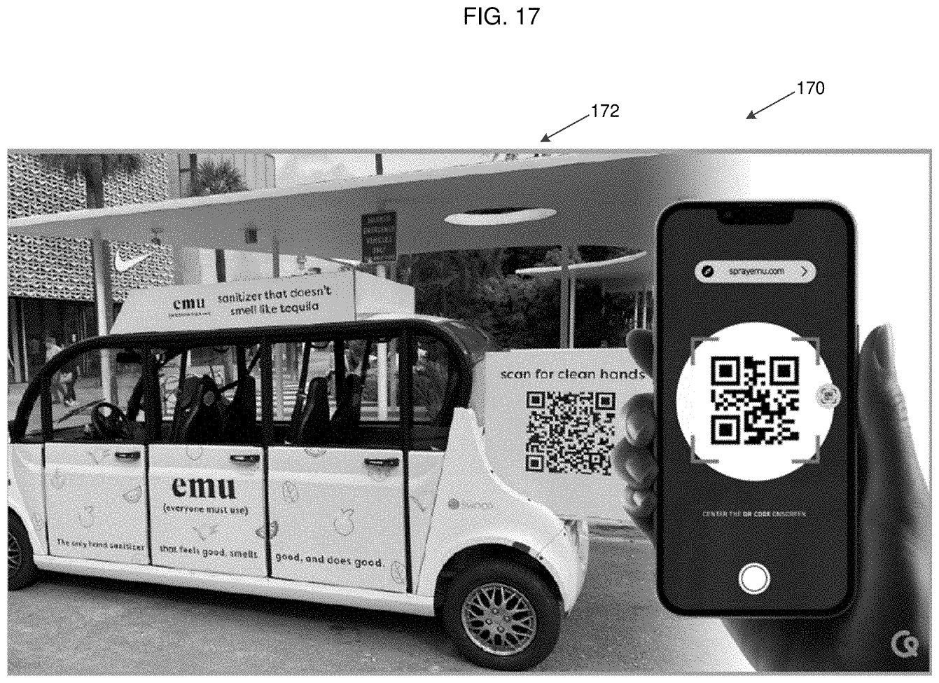

FIG. 17 illustrates a QR code reader enabled offer redemption feature of the system of the present disclosure. Using the interface screen 170 generated by the system, a user can capture an image (e.g., using the camera of a smart phone) of a QR code displayed by a vendor/advertiser/third party/etc., such as a QR code displayed on a billboard 172. Once the QR code has been captured, the system processes the code to identify and retrieve information provided by the application, such as a value exchange offer.

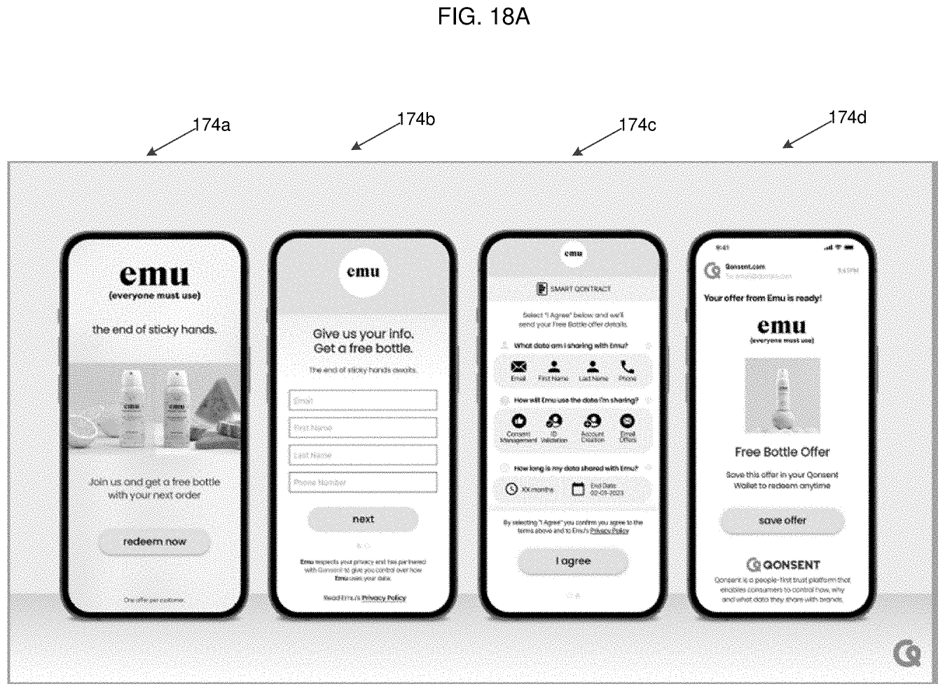

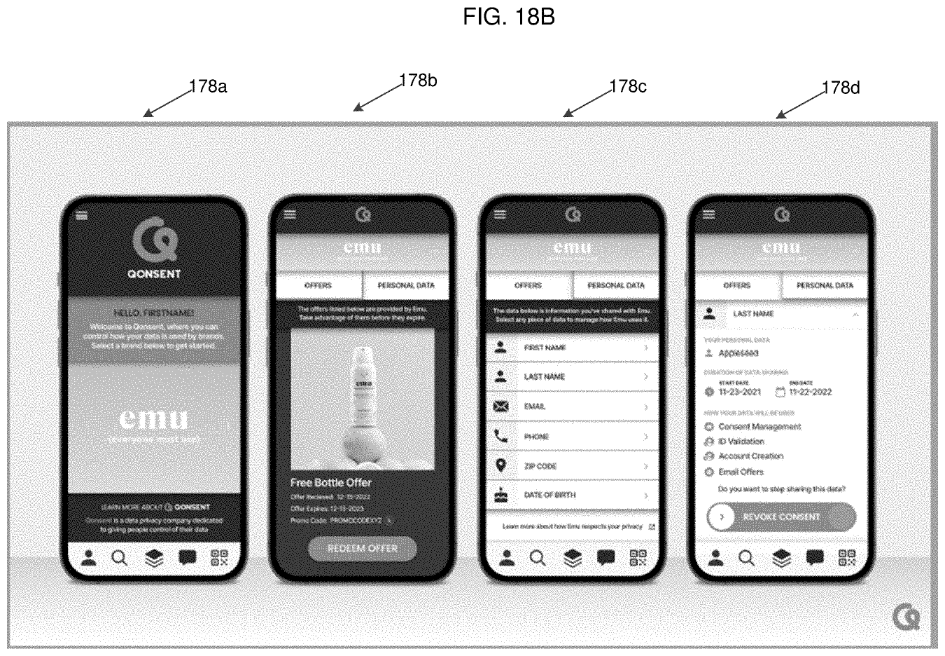

FIGS. 18A-18B are screenshots illustrating value exchange offer screens generated by the system of the present disclosure. The value exchange offer screens depicted in FIG. 18A may be generated after scanning a QR code as described with reference to FIG. 17. The system generates a first screen 174a depicting the offer scanned from the QR code. If the offer is accepted by the user, the system also generates a second screen 174b depicting an account creation screen. Creating an account prompts the system to generate a third screen 174c depicting a smart contract detailing the PII sharing policies associated with the created account. The system may also generate a fourth screen 174d depicting a value exchange offer that may be earned from sharing PII. In some embodiments, the value exchange offer may be sent to a user's email account or may be depicted as part of a digital wallet associated with the system.

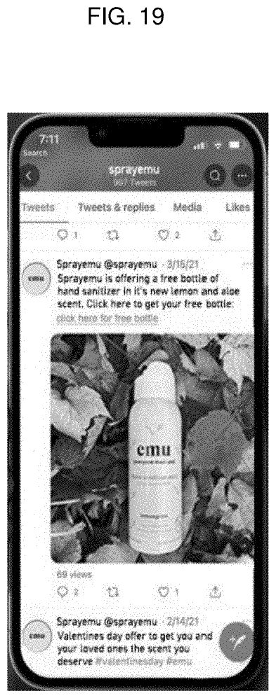

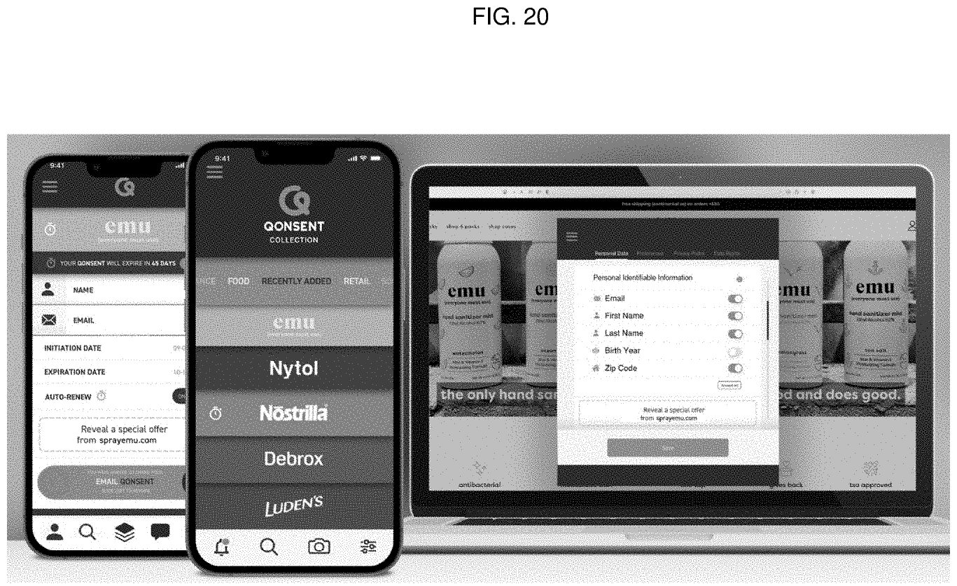

FIG. 19 is a screenshot illustrating embedded, electronic access to the features of the systems and methods of the present disclosure in-line within an electronic advertisement (e.g., an advertisement in a social media feed). It is noted that all of the features of the systems and methods of the present disclosure could be accessed using one or more links embedded within another entity such as a social media feed, advertisement, ad unit, etc. For example, as shown in the TWITTER feed illustrated in FIG. 19, an advertisement for a spray product (SPRAYEMU by the EMU company) is displayed in the TWITTER feed, and includes a link that can be tapped by the user (“click here for free bottle” link). By clicking on the link, the system provides seamless access for the user to the user interface screens discuss above in connection with FIGS. 18A-18B, so that the user can manage and control usage of the user's PII by the EMU company. As can be seen in FIG. 20, the user's PII wallet is updated with a PII card associated with the EMU company, which the user can utilize to manage and control usage of the user's PII by the EMU company.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A personally-identifiable information (PII) management system for managing electronic data privacy, consent, and control in electronic transactions, comprising:
a database; and
a computing device in communication with the database, the computing device programmed to perform the steps of:
generating a campaign identifier tag associated with an entity's branding campaign data stored in the database;
displaying on a display of the computing device a contract for a user to share PII associated with the user with the entity;
determining if the user agrees to the contract; and
if the user agrees to the contract, transmitting PII associated with the user to the entity.

2. The system of claim 1, wherein the campaign identifier tag comprises a Uniform Resource Locator (URL) address and/or a QR code.

3. The system of claim 1, further comprising a firewall and an integration software engine.

4. The system of claim 1, wherein the database is configured to store the PII.

5. The system of claim 4, wherein the PII is retrieved from the database.

6. The system of claim 1, wherein the computing device is further programmed to perform the step of presenting a landing page to the user of the system, the landing page including overlay data associated with the tag.

7. The system of claim 1, wherein the computing device is further programmed to perform the step of creating analytics associated with the interaction between the entity and the user.

8. The system of claim 1, wherein the computing device is further programmed to perform the step of storing the contract in the database and associating the contract with the user.

9. The system of claim 8, wherein the contract is a blockchain-based smart contract.

10. The system of claim 1, wherein the computing device is further programmed to perform the step of monitoring usage of the PII associated with the user to ensure usage of the PII by the entity is in accordance with the terms of the contract.

11. The system of claim 1, wherein the campaign identifier tag is accessible through one or more of a social media feed, and advertisement, or an advertisement unit.

12. A method for managing electronic data privacy, consent, and control in electronic transactions, comprising the steps of:
retrieving from a database data associated with an entity's branding campaign;
generating a campaign identifier tag associated with the entity's branding campaign data;
displaying in a display of a device a contract for a user to share PII associated with the user with the entity;
determining if the user agrees to the contract; and
if the user agrees to the contract, transmitting PII associated with the user to the entity.

13. The method of claim 12, wherein the campaign identifier tag comprises a Uniform Resource Locator (URL) address and/or a QR code.

14. The method of claim 12, further comprising retrieving the PII associated with the user from the database.

15. The method of claim 14, further comprising allowing one or more computer systems of the entity to access the PII from the database.

16. The method of claim 12, further comprising generating a PII management wallet for the user.

17. The method of claim 16, wherein the wallet is configured to enable a user to control access and usage of the PII by the entity.

18. The method of claim 12, further comprising creating and storing, in the database, analytics associated with the interaction between the entity and the user.

19. The method of claim 12, further comprising storing the contract in the database and associating the contract with the user.

20. The method of claim 19, wherein the contract is a blockchain-based contract.

21. The method of claim 12, further comprising monitoring usage of the PII associated with the user to ensure usage of the PII by the entity is in accordance with the terms of the contract.

22. The method of claim 12, wherein the campaign identifier tag is accessible through one or more of a social media feed, and advertisement, or an advertisement unit.
